(19) United States
(12) Patent Application Publication
(10) Pub. No.: US 2024/0065475 A1
(43) Pub. Date: Feb. 29, 2024

(54) OUTDOOR HEAT PRESERVATION DINING STOVE

(71) Applicant: SUNNEX PRODUCTS (GUANGDONG) LIMITED, Taishan (CN)

(72) Inventors: Liming YU, Hong Kong (CN); Weixing TAN, Taishan (CN)

(21) Appl. No.: 18/454,496

(22) Filed: Aug. 23, 2023

(30) Foreign Application Priority Data
Aug. 23, 2022 (CN) 202222227954.9

(51) Int. Cl. A47J 36/24

(52) U.S. Cl. CPC A47J 36/2405

(57) ABSTRACT

An outdoor heat preservation dining stove includes a base and a plate. The top of the base is recessed inwardly to form in turn a holding cavity and a water storage cavity which are connected, wherein the water storage cavity is used for storing hot water, and the plate is placed in the holding cavity with its bottom contacting the hot water in the water storage cavity. The inner side of the base is provided with an overflow groove, located at the interface between the holding cavity and the water storage cavity, to receive the hot water overflowing from the water storage cavity. The heat preservation dining stove has the advantages of easy operation and maintenance, simple manufacturing process, preventing the food pan from floating and improving the heat preservation effect, convenient to carry and not affect the taste of food.

### CROSS-REFERENCE TO RELATED APPLICATIONS

This application claims the priority of Chinese Patent Application No. 202222227954.9, filed on Aug. 23, 2022, the entire contents of which are hereby incorporated by reference.

### FIELD OF TECHNOLOGY

The present application relates to the technical field of dining stoves, in particular to a outdoor heat preservation dining stove.

### BACKGROUND

As a container for food, a dining stove is mainly used in restaurants and hotels. In the process of use, food is placed on the food pan, and the bottom is set with a heating device, allowing to warm food on the plate, so as to maintain the temperature of the food while serving. As the heating device requires power supply, so when a power outage occurs or it is difficult to charge in the use environment, the heating function is not working, making the stove lose its heating function, and it is hard to ensure the temperature of the food during the dining process with only the insulation performance of the stove itself, which greatly affects the food flavor. To this end, the industry has introduced a variety of heating methods to solve the problem of heat preservation and warming food without electricity, the most commonly used is through hot water. When using this method, first add enough hot water to the basin at the bottom of the stove, and then place the food pan in the hot water, so as to realize the heating and insulation of food. However, when used in actual situation, it is not easy to add the correct mount of water, and if the hot water added is too little, the hot water and the food pan is not fully in contact, resulting in poor heating and insulation effect; if the hot water added is too much, making the water level too high, the food plate will float in the basin due to buoyancy, resulting in rapid heat loss, and at the same time, the floated plate will collide with the basin from time to time, affecting the stability of the food pan when serving food. At present, hot water is usually manually scooped out when too much added, which is time-consuming and laborious, and is disadvantageous to maintain the neatness of the countertop. In addition, currently a dining stove is generally bulky with complex production process, high cost, and inconvenient operation and maintenance. Keeping hot water and the food pan in contact will enable more efficient heat transfer between the hot water and the food pan.

### SUMMARY

An aspect relates to a heat preservation dining stove which has the advantages of easy operation and maintenance, simple manufacturing process, preventing the food pan from floating and improving the heat preservation effect.

In accordance with the present application, a heat preservation dining stove is provided which includes a base and a plate. The top of the base is recessed inwardly to form in turn a holding cavity and a water storage cavity which are connected, wherein the water storage cavity is used for storing hot water, and the plate is placed in the holding cavity with its bottom contacting the hot water in the water storage cavity. The inner side of the base is provided with an overflow groove, located at the interface between the holding cavity and the water storage cavity, to receive the hot water overflowing from the water storage cavity.

When using this heat preservation dining stove, in the process of placing the plate to the holding cavity, excess hot water is able to be discharged into the overflow groove, so as to prevent the heat loss caused by the excessive gap between the plate and the base due to the floating of the plate, which is a fault tolerance function. At the same time, avoiding the floating of the plate is also able to ensure the fitting between the plate and the base, which improves the stability of the plate when serving food.

These and other features, aspects and advantages of the present application will become better understood with reference to the following drawings, description and claims.

### BRIEF DESCRIPTION

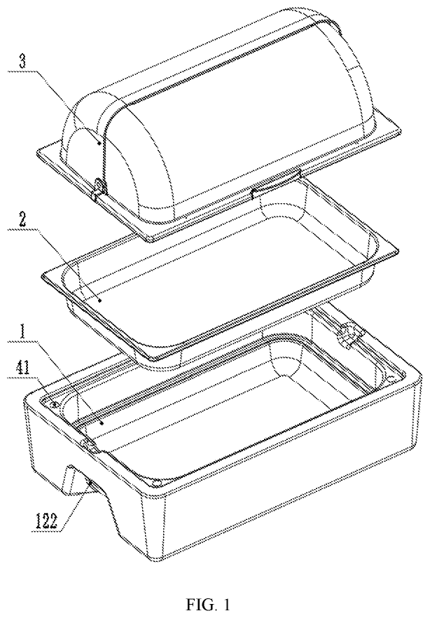

FIG. 1 is an exploded structural view of the heat preservation dining stove according to the present application;

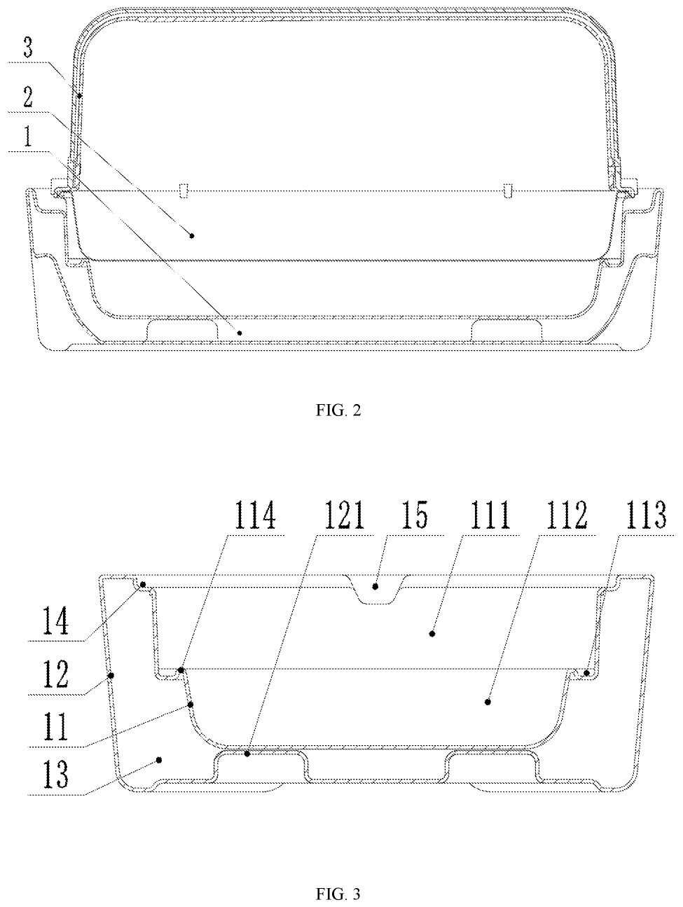

FIG. 2 is a cross-sectional view of the heat preservation dining stove according to the present application;

FIG. 3 is a cross-sectional view of the base of the heat preservation dining stove according to the present application;

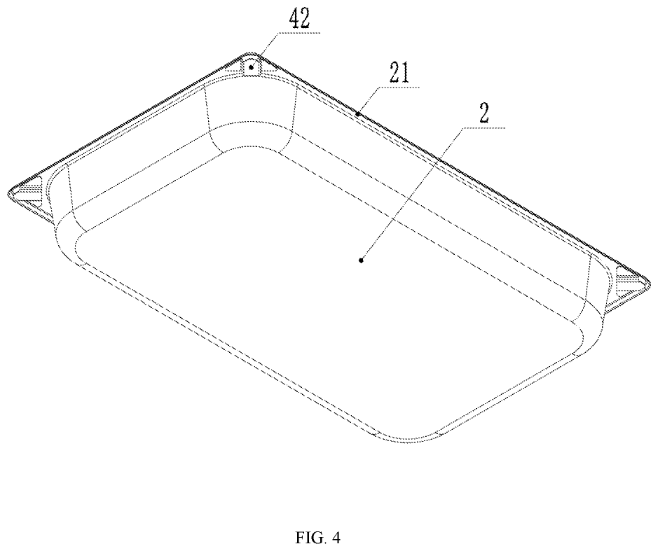

FIG. 4 is a schematic structural view of the food pan of the heat preservation dining stove according to the present application;

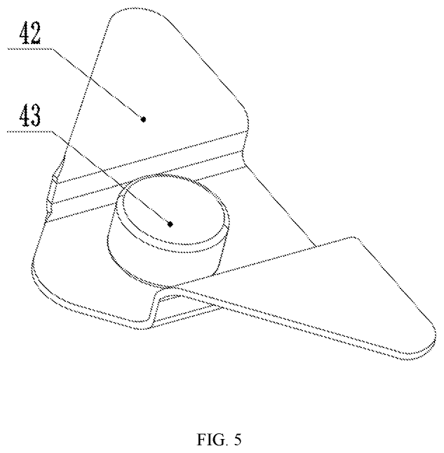

FIG. 5 is a mating diagram of the mount and the second positioning member of the heat preservation dining stove according to the present application.

The designations in the accompanying drawings are: 1 base; 11 inner part; 111 holding cavity; 112 water storage cavity; 113 overflow groove; 114 convex ring; 12 outer part; 121 support bump; 122 recess; 13 insulation cavity; 14 snap-in slot; 15 lifting slot; 2 plate; 21 support part; 3 cover; 41 a first positioning member; 42 mount; 43 a second positioning member.

### DETAILED DESCRIPTION

The present application provides a heat preservation dining stove. As shown by FIGS. 1-5, FIG. 1 is an exploded structural view of the heat preservation dining stove; FIG. 2 is a cross-sectional view of the heat preservation dining stove; FIG. 3 is a cross-sectional view of the base of the heat preservation dining stove; FIG. 4 is a cross-sectional view of the plate of the heat preservation dining stove; FIG. 5 is a mating diagram of the mount and the second positioning member of the heat preservation dining stove.

The heat preservation dining stove includes a base 1, a plate 2 and a cover 3. The base 1 is made of a plastic material with an open top and the plate 2 is made of metal material with good temperature conductivity. The plate 2 is placed into the base 1 through the open top. The plate 2 is used for holding food. The cover 3 is covered on the base 1 to form a closed space with the base 1 where the plate 2 is located, thus reducing the heat loss of food in the plate 2 and achieving heat preservation effect.

To further improve the heat preservation effect, the base 1 has a double-layer structure including an inner part 11 and an outer part 12. The base 1 is an integral forming structure that the inner part 11 is nested inside the outer part 12 and attached to the outer part 12 with the joining area sealed, so as to form a closed insulation cavity 13 between the inner part 11 and the outer part 13. The insulation cavity 13 may be a hollow structure, or insulation material may be added to the insulation cavity 13. The base 1 might also be a separate structure of the inner part 11 and the outer part 12, and it is necessary to ensure that the inner part 11 and outer part 12 can be sealed connected. The separate structure is able to realize adding or cleaning insulation material to the insulation cavity 13, or realize the replacement of different inner parts 11 according to different size of the plate 2, to improve versatility.

The inner part 11 is recessed inwardly to form in turn a holding cavity 111 and a water storage cavity 112 which are connected. The water storage cavity is used for storing hot water. The inner part 11 is provided with an overflow groove 113 on the side, the overflow groove 113 is located at the interface between the holding cavity 111 and the water storage cavity 112, to receive the hot water overflowing from the water storage cavity 112. The recessed direction of the overflow groove 113 is the same as the recessed direction of the water storage cavity 112. The overflow groove 113 is located at the outer side of the water storage cavity 112. A convex ring 114 is provided at the joint of the overflow groove 113 and the water storage cavity 112, and a certain gap is retained between the convex ring 114 and the plate 2, so as to prevent interference between the convex ring 114 and the plate 2 in the case that heat loss is minimized.

The bottom surface of the outer part 12 is recessed into the insulation cavity 13 to form a plurality of support bumps 121, wherein the top surface of the support bump 121 is spaced opposite to the inner part 11. When the inner part 11 is deformed due to the weight of hot water in the water storage cavity 112, the inner part 11 presses against the support bumps 121, thus achieving support for the inner part 11. The outer part 12 is further provided with a recess 122 on the side. The recess 122 may be regular or irregular in shape. The recess 122 facilitates an operator to lift up the base 1 for moving.

The top of the base 1 is provided with a snap-in slot 14. The snap-in slot 14 is embedded with a first positioning member 41. The base 1 is further provided with a lifting slot 15, wherein one end of the lifting slot 15 is connected to the outside and the other end is connected to the holding cavity 111, so that the plate 2 can be easily taken out. There can be two lifting slots 15 provided symmetrically on both sides of the base 1, or a single lifting slot 15 provided only on one side to reduce heat loss.

The plate 2 is placed in the holding cavity 111 with its bottom in contact with the hot water in the water storage cavity 112 and its top outer edge forming a support part 21 against the snap-in slot 14. The first positioning member 41 and the second positioning member 43 are matched with each other and are mutually attracted. The first positioning member 41 and the second positioning member 43 may be suction cups, adhesives and other structures. In this embodiment, at least one of the first positioning member 41 or the second positioning member 43 is a magnet while the other is a magnet or an iron sheet, so as to achieve the effect of mutual suction. The support part 21 is further provided with a mount 42 in the shape of square pulses, and the second positioning member 43 is stuck in its recessed area, so as to prevent the second positioning member 43 from falling off.

The cover 3 is covered on the base 1, which may have a variety of structural forms. In this embodiment, the cover 3 is a flip cover, which may also be a flat top cover and many other structures.

In use, firstly the cover is opened, then hot water is filled into the water storage cavity 112 of the base 1, and the temperature of the hot water can be set according to the actual situation. The inner part 11 can be provided with a water level scale, thus intuitively prompting the filled water. After completing hot water filling, the plate 2 with food is placed into the base 1 to immerse in the hot water by its own gravity, and the discharged hot water over the convex ring 114 is able to flow into the overflow groove 113, so as to ensure the plate 2 contacting against the snap-in slot 14, avoiding the plate 2 from disengaging from the snap-in slot 14 due to buoyancy and improving the stability of the plate 2 after it is placed. At the same time, the first positioning member 41 and the second positioning member 43 attract each other, and their attraction may further provide a force to overcome the buoyancy, and further position the plate 2 to avoid movement in the process of taking food. When the plate 2 is placed, the cover 3 is closed, and the dinning stove is able to be picked up by reaching into the recess 122 to complete the movement, placement and adjustment of the plate 2.

When food needs to be changed, the plate 2 needs to be changed to prevent food odor. In this case, the operator needs to open the cover 3, fingers reach into the lifting slot 15 and contact with the bottom of the edge of the plate 2, so as to lift the plate 2 from the base 1 and switch another plate 2, which is easy and fast.

If the hot water level exceeds the water level scale due to the operator's mistake during the filling process, the operator is able to simply stop filling immediately without dumping or pumping the excess hot water because the overflow groove 113 is able to hold the excess hot water.

As above described, when using the dining stove of the present application, in the process of placing the plate 2 to the holding cavity 113, excess hot water is able to be discharged into the overflow groove 113, so as to prevent the heat loss caused by the excessive gap between the plate 2 and the base 1 due to the floating of the plate 2, which is a fault tolerance function. At the same time, avoiding the floating of the plate 2 is able to also ensure the fitting between the plate 2 and the base 1, which improves the stability of the plate 2 when serving food. In addition, the base 1 adopts a double-layer structure for heat preservation, which is able to keep food warm for at least 3 hours and meet the needs of the majority of the market.

It should be understood that the terminology used herein is for the purpose of describing particular embodiments only and is not intended to be limiting of the application. As used herein, the term “up”, “down”, “before” and “after”, “left”, “right” and “vertical”, “level”, “top”, “bottom” “within” and “outside” indicates a location or position based on the orientation or positional relationship shown in the drawings, and is only for the convenience of description and simplification, rather than indicating or implying the device or element must have a specific orientation, be constructed and operated in a specific orientation. The terms first, second are only used for description, and are not to be understood as indicating or implying relative importance or implicitly specifying the number of technical features, i.e. a feature defined with “first” or “second” may explicitly or implicitly include at least one such feature. In addition, unless otherwise specified, “plurality” means two or more.

It should be noted that, in the description of this application, unless otherwise expressly specified and qualified, the terms “fixed”, “attached” and “connected” should be interpreted broadly, for example, they may be fixed connections, detachable connections or integrated connections; they may be an be mechanical connection, or an electrical connection; they can be directly connected, indirectly connected through an intermediary, or connected within two components. For ordinary technical personnel in this field, the specific meaning of the above terms in this application is able to be understood on a case-by-case basis.

Although the invention has been illustrated and described in greater detail with reference to the preferred exemplary embodiment, the invention is not limited to the examples is closed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A outdoor heat preservation dining stove, wherein the heat preservation dining stove comprises a base and a plate; the top of the base is recessed inwardly to form in turn a holding cavity and a water storage cavity which are connected; the water storage cavity is used for storing hot water; the plate is placed in the holding cavity with its bottom contacting the hot water in the water storage cavity; the inner side of the base is provided with an overflow groove, located at the interface between the holding cavity and the water storage cavity, to receive the hot water overflowing from the water storage cavity.

2. The outdoor heat preservation dining stove of claim 1, wherein the recessed direction of the overflow groove is the same as that of the water storage cavity.

3. The outdoor heat preservation dining stove of claim 1, wherein the base comprises an inner part and an outer part; the inner part and the outer part are an integral forming structure or a separate structure; the inner part is nested inside the outer part and attached to the outer part with the joining area sealed, so as to form a closed insulation cavity between the inner part and the outer part; the inner part is recessed to form the overflow groove.

4. The outdoor heat preservation dining stove of claim 1, wherein the base is provided with a snap-in slot at the top, and the outer edge of the top of the plate contacts against the snap-in slot.

5. The outdoor heat preservation dining stove of claim 4, wherein a first positioning member is embedded in the snap-in slot, a second positioning member is provided on the outer edge of the top of the plate, and the first positioning member and the second positioning member are matched with each other and mutually attracted.

6. The outdoor heat preservation dining stove of claim 5, wherein the plate is provided with a mount, and the second positioning member is stuck between the mount and the plate.

7. The outdoor heat preservation dining stove of claim 3, wherein the bottom surface of the outer part is recessed into the insulation cavity to form a plurality of support bumps, and the top surfaces of the support bumps are spaced opposite to the inner part with space.

8. The outdoor heat preservation dining stove of claim 1, wherein the top of the base is provided with a lifting slot to facilitate to remove the plate from the base.

9. The outdoor heat preservation dining stove of claim 1, wherein the outside of the base is further provided with a recess with a regular or irregular shape, which is convenient for lifting the base for moving.
